(19) United States
(12) Patent Application Publication
(10) Pub. No.: US 2023/0258307 A1
(43) Pub. Date: Aug. 17, 2023

(54) Electronic candle structure and production method, and wax shell of the electronic candle

(71) Applicant: Hai Song DONG, Guangdong (CN)

(72) Inventor: Hai Song DONG, Guangdong (CN)

(21) Appl. No.: 17/921,350

(22) PCT Filed: Apr. 19, 2021
(86) PCT No.: PCT/CN2021/087997

§ 371 Date: Oct. 25, 2022

(30) Foreign Application Priority Data
May 8, 2020 (CN) 202010379973.6

(51) Int. Cl. F21S 10/04; B29C 39/10; B29C 39/26; B29C 39/00

(52) U.S. Cl. CPC F21S 10/04; B29C 39/10; B29C 39/26; B29C 39/003; B29K 2091/00

(57) ABSTRACT

Disclosed are an electronic candle structure and production method, and wax shell of the electronic candle. The electronic candle, comprising a wax shell, an core system and a lining, the wax shell is formed by directly cooling and solidifying melted wax on the outer surface of the lining, the outer surface of the wax shell is formed by the inner surface of a female mold, and the main body of the core system is fixed in the inner space of the lining. Compared with the prior art, the invention greatly reduces the consumption of raw materials and energy in the production process, shortens the production cycle, improves the production efficiency, and effectively reduces the costs. Moreover, the overall mechanical strength of the product is enhanced to prevent the product from deformation under the long-term use conditions at relatively high environmental temperatures, and improve the durability of the product.

### BACKGROUND OF THE INVENTION

The invention relates to the technical field of simulated electronic candles, in particular to a structure and a production method of an electronic candle.

As an important decoration, candles are widely used in birthday parties, candlelit dinners and other important occasions to adjust the atmosphere. However, the traditional candle not only produces smoke and pollutes the environment, but also has potential safety hazards. Due to their safety and environmental protection, electronic candles have been replacing traditional candles and becoming a widely consumed commodity.

Due to the market demand for high-fidelity of electronic candles, the outer surfaces of electronic candles are usually made of wax, which keeps the look and feel of the outer surfaces the same as those of traditional candles. The conventional electronic candle comprises a wax shell 1 and a core system 2, wherein the core system 2 comprises a core system main body 3, a flame head 4 and a light source 9 arranged inside the flame head; a wax shell fixing surface 5 at the bottom of the core system main body 3 is fixed in an inner space 8 of the wax shell 1; a top central fixing surface 6 of the core system is matched with a wax shell flame head through hole 7; and the flame head 4 is positioned above the wax shell 1, as shown in FIG. 1-4. The method for producing the wax shell in the prior art comprises the following steps: Manufacture a female mold for forming a wax shell, wherein the surface of the inner cavity of the female mold is the outer surface of the wax shell, pour melted wax into the inner cavity of the female mold, namely the melted wax forms the shape of a solid wax shell in the female mold, the melted wax contacting the inner surface of the female mold starts to be cooled and hardened at first, and gradually advances towards the center; pour out the melted wax which is not hardened in the center after the outer surface of the wax shell forms a certain hardening thickness. Then take the preliminarily formed wax shell out from the female mold, and the wax shell 1 at this time initially has the appearance of FIG. 4. The difference is that the inner cavity in the wax shell is formed by directly pouring out the non-hardened melted wax, so the shape of the cavity is irregular and inconsistent, which may affect the assembly of the core system. Therefore, the preliminarily formed wax shell needs to be processed again, and the excess wax is removed by machining to form a wax shell with a regular cavity, which can be used for assembling the core system. The core system is usually fixed to the inner cavity of the wax shell by melted wax or other adhesive materials through the fixing surface of the wax shell thereon. The structure and production method of the wax shell at present lead to low production efficiency and high cost. First of all, forming a hollow wax shell requires melted wax equivalent to the volume of a solid wax shell that is, it needs to consume more energy to heat to form more melted wax for pouring the wax shell. In addition, the more melted wax is poured, the longer the cooling and forming duration is. Generally, the cooling time required for forming a wax shell is about 0.5-3 hours. Secondly, the material of the wax shell is characterized by low melting point and low mechanical strength, and does not have a lining made of a material with higher mechanical strength as a support, so the wall of the wax shell must maintain a certain average thickness to meet the mechanical strength required in the wax shell forming and processing process and normal use process, and the average thickness is usually more than 5 mm, and the structure of the wax shell also leads to an increase in the amount of wax used.

### BRIEF SUMMARY OF THE INVENTION

The technical problem to be solved by the invention is to provide an electronic candle structure, a production method, and a wax shell of the electronic candle, with high production efficiency, low cost, and high mechanical strength, aiming at the defects of the prior art.

The invention provides an electronic candle, which comprises a wax shell and a core system, in addition, the electronic candle also comprises a lining, wherein the wax shell is formed by directly cooling and solidifying melted wax on the outer surface of the lining, the outer surface of the wax shell is formed by the inner surface of a female mold, and the core system main body is fixed in the inner space of the lining.

Further,

wherein the lining comprises an upper wall and a side wall, and an inner space enclosed by the upper wall and the side wall.

wherein the average wall thickness of the wax shell is 0.6 to 3 mm.

wherein the center of the lining upper wall is provided with a top fixing through hole, a top central fixing cylindrical surface is arranged below the flame head of the core system, and the top central fixing cylindrical surface is in contact with the top fixing through hole.

wherein the inner surface of the side wall of the lining is provided with at least two fixing buckles for fixing the core system on the lining.

wherein the core system is provided with a clearance position and a fixing position, when the core system is assembled on the lining, the fixing buckles on the lining are firstly placed on the clearance position, and then the lining and the core system are relatively rotated so that the fixing buckle on the lining is rotated to the fixing position on the core system to be fixed.

wherein the lining is made of semitransparent or transparent material.

The invention provides an electronic candle, comprising a wax shell, a core system and a lining; the lining comprises an upper wall and a side wall, and an inner space enclosed by the upper wall and the side wall; the main body of the core system is fixed in the inner space of the lining; the wax shell is wrapped on the outer surface of the lining with a uniform wall thickness, and the average wall thickness of the wax shell is 0.6-3 millimeters.

The invention provides a production method of an electronic candle, comprising the following steps:

step 1: fix a lining on the outer surface of a male mold, and pour a certain amount of melted wax into a female mold;

step 2: place the male mold fixed with a lining into the female mold, extrude melted wax in the female mold to flow to a gap between the side wall of the lining and the side wall of the female mold and a gap between the upper wall of the lining and the bottom surface of the female mold, and cool and solidify the melted wax to form a wax shell;

step 3: sequentially take down the female mold and the male mold to obtain a wax shell lining component that wraps the wax shell outside the lining;

step 4: assemble the core system main body of the core system into the cavity of the wax shell lining component to complete the manufacturing process.

wherein in step 2, the height of the lining is lower than the height of the female mold, and a gap between the side wall of the female mold and the side wall of the male mold forms a waste groove above the female mold to contain excess melted wax.

wherein the height of the waste groove is more than 5 mm.

wherein the upper part of the waste groove is open.

wherein the lining is made of semitransparent or transparent material.

wherein the average wall thickness of the wax shell is 0.6 to 3 millimeters.

wherein the inner surface of the side wall of the lining is provided with at least two fixing buckles, and the outer surface of the male mold is provided with at least two clearance grooves and fixing grooves corresponding to the fixing buckles; in the wax shell forming process, the fixing buckle of the lining passes through the clearance groove on the male mold from bottom to top, and when the fixing buckle reaches the height of the fixing groove, the lining is rotated by a certain angle so that the fixing buckle is clamped in the fixing groove; when the lining needs to be detached from the male mold, the lining is rotated in the opposite direction so that the fixing buckle is rotated to the position of the clearance groove, and the fixing buckle moves from top to bottom through the clearance groove, so that the lining is detached from the male mold.

wherein the core system is provided with a clearance position and a fixing position, when the core system is fixed on the lining, the fixing buckle on the lining is firstly placed on the clearance position, and then the lining and the core system are relatively rotated so that the fixing buckle on the lining is rotated to the fixing position on the core system to be fixed.

The invention provides a production method of an electronic candle, comprising the following steps:

step 1: pour a certain amount of melted wax into a female mold;

step 2: insert and fix a lining with a height higher than that of the female mold in the female mold from top to bottom, extrude melted wax in the female mold to flow to a gap between the side wall of the lining and the side wall of the female mold and a gap between the upper wall of the lining and the bottom surface of the female mold, and cool and solidify the melted wax to form a wax shell;

step 3: take down the female mold, and cut off the excess portion of the lining to obtain a wax shell lining component that wraps the wax shell outside the lining;

step 4: assemble the core system main body of the electronic candle core system into the cavity of the wax shell lining component to complete the manufacturing process.

wherein the female mold is provided with a clearance position and a fixing position, and the outer surface of the lining is provided with a fixing buckle; when the lining is fixed with the female mold, the fixing buckle on the outer surface of the lining is aligned with the clearance position on the female mold from top to bottom to assemble the lining into the female mold, and then the lining and the female mold are relatively rotated to a position where the fixing buckle is clamped at the fixing position to be fixed; the lining and the female mold are oppositely rotated away from the fixing position to remove the female mold.

The invention provides a wax shell of an electronic candle, wherein the wax shell is formed by directly cooling and solidifying melted wax on the outer surface of a lining, and the outer surface of the wax shell is formed by the inner surface of a female mold.

wherein the average wall thickness of the wax shell is 0.6 to 3 mm.

wherein the lining is made of semitransparent or transparent material.

Compared with the prior art, the invention has the technical effects that: it greatly reduces the consumption of raw materials and energy in the production process, shortens the production cycle, improves the production efficiency, and effectively reduces the costs. Moreover, the overall mechanical strength of the product is enhanced to prevent the product from deformation under the long-term use conditions at relatively high environmental temperatures, and improve the durability of the product.

### BRIEF DESCRIPTION OF THE DRAWINGS

FIG. 1 is a schematic view of the appearance and shape of a conventional electronic candle;

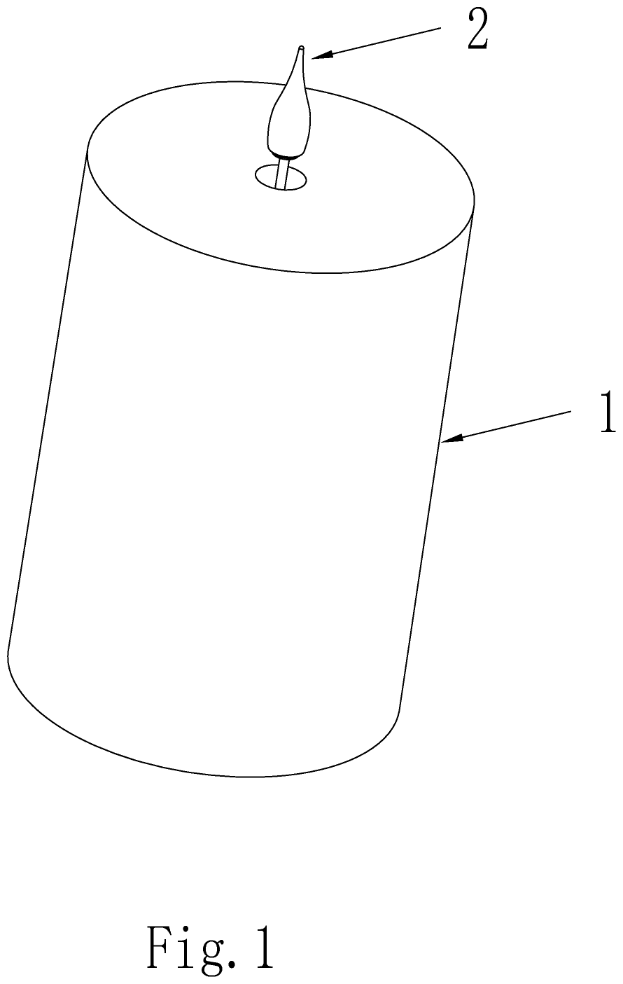

FIG. 2 is an exploded schematic view of a conventional electronic candle;

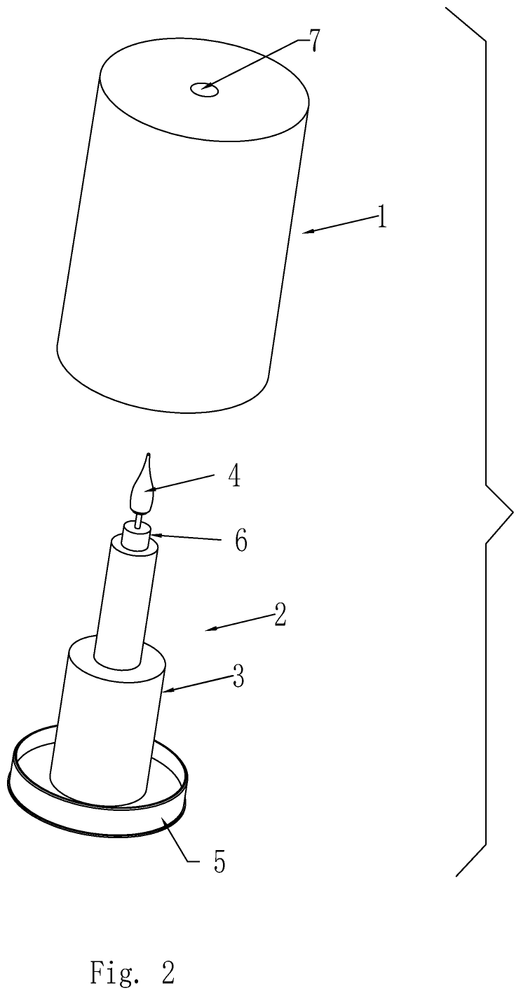

FIG. 3 is a schematic cross-sectional view of a conventional electronic candle;

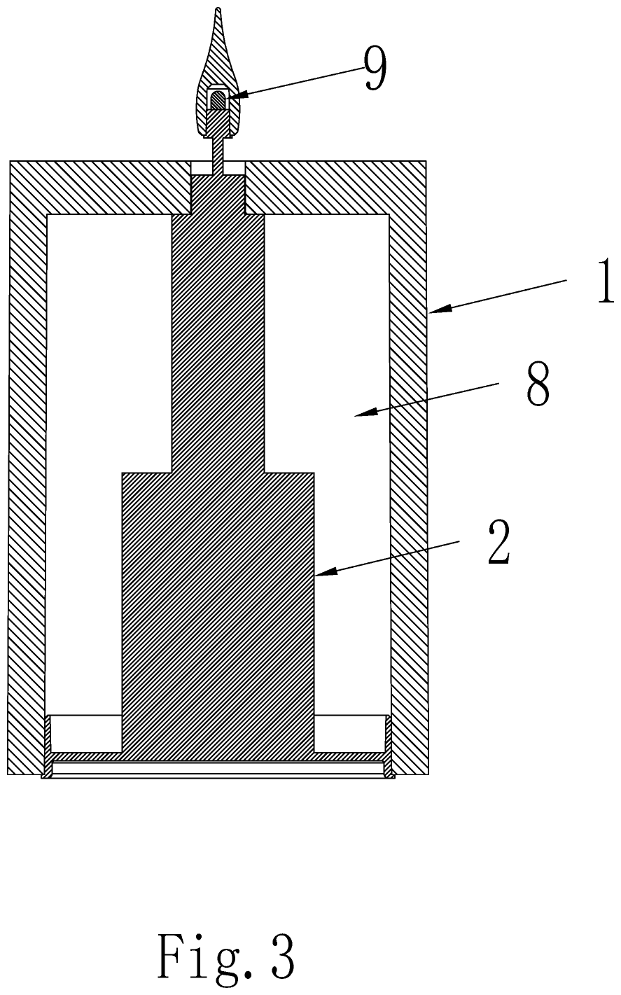

FIG. 4 is a schematic view of the shape of a conventional electronic candle wax shell;

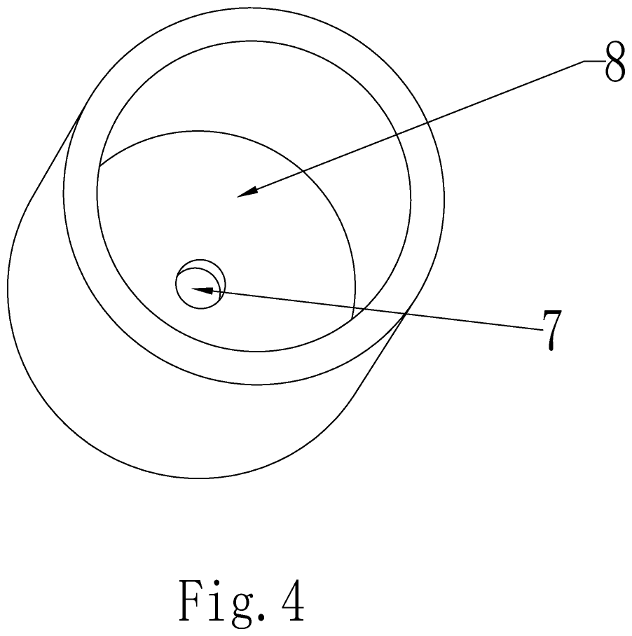

FIG. 5 is a schematic cross-sectional view of an electronic candle according to the present invention;

FIG. 6 is an exploded schematic view of an electronic candle according to the present invention;

FIG. 7 is a schematic diagram of the shape and structure of the core system of an electronic candle according to the present invention;

FIG. 8 is a schematic view of the shape and structure of a lining of an electronic candle according to the present invention;

FIG. 9 is a schematic cross-sectional structural view of a lining of an electronic candle according to the present invention;

FIG. 10 is an exploded schematic view of a female mold, a male mold and a lining used in an embodiment of an electronic candle production method according to the present invention;

FIG. 11 is a schematic view of the shape and structure of a male mold used according to an embodiment of the production method of an electronic candle the present invention;

FIG. 12 is a schematic cross-sectional structural view of a wax shell in a mold opening state before molding according to an embodiment of the production method of the electronic candle of the present invention;

FIG. 13 is a schematic cross-sectional structural view of a mold-assembly state in wax shell molding according to an embodiment of the production method of an electronic candle of the present invention;

FIG. 14 is a schematic cross-sectional structural view of a wax shell in a mold-disassembly state after molding according to an embodiment of the production method of the electronic candle of the present invention;

FIG. 15 is a cross-sectional structural schematic view of an embodiment of an electronic candle production method according to the present invention, in which the wax shell is removed from the male mold after being molded;

FIG. 16 is a schematic cross-sectional structure view of an embodiment of the production method of an electronic candle according to the present invention, in which the wax shell has been formed and the waste wax has been removed.

FIG. 17 is an exploded schematic view of a female mold and a lining used in another embodiment of an electronic candle production method according to the present invention;

FIG. 18 is a schematic structural view of the combination of a female mold and a lining used in another embodiment of the production method of an electronic candle according to the present invention;

FIG. 19 is a schematic structural view of a female mold used in another embodiment of an electronic candle production method according to the present invention;

FIG. 20 is a schematic cross-sectional structural view of mold-opening state before the wax shell is molded, according to another embodiment of the production method of an electronic candle in the present invention;

FIG. 21 is a schematic cross-sectional structural view of a mold-assembly state in wax shell molding according to another embodiment of the production method of an electronic candle of the present invention;

FIG. 22 is a schematic cross-sectional structural view of a mold-disassembly state after the wax shell is molded according to another embodiment of the production method of an electronic candle in the present invention.

### DETAILED DESCRIPTION OF THE INVENTION

The embodiments of the present invention are hereby described in detail with reference to the accompanying figures.

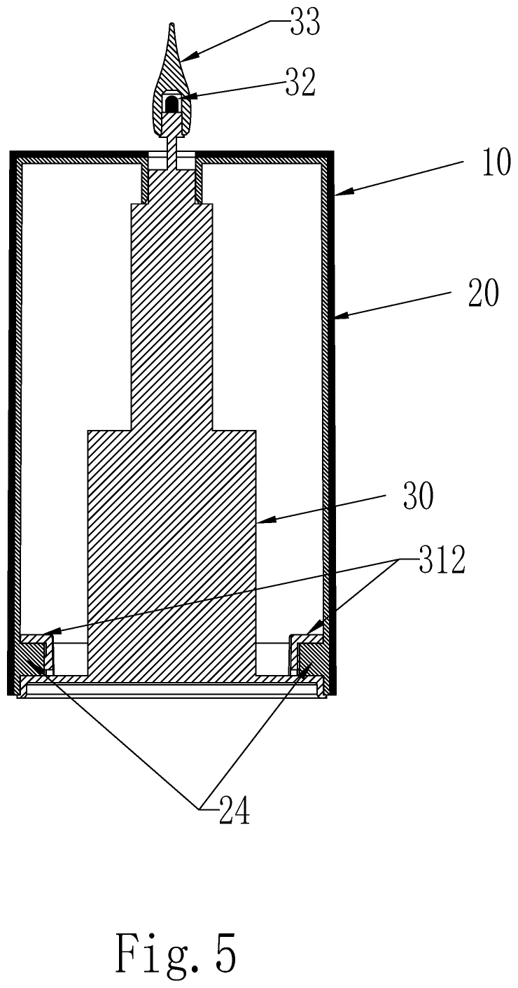

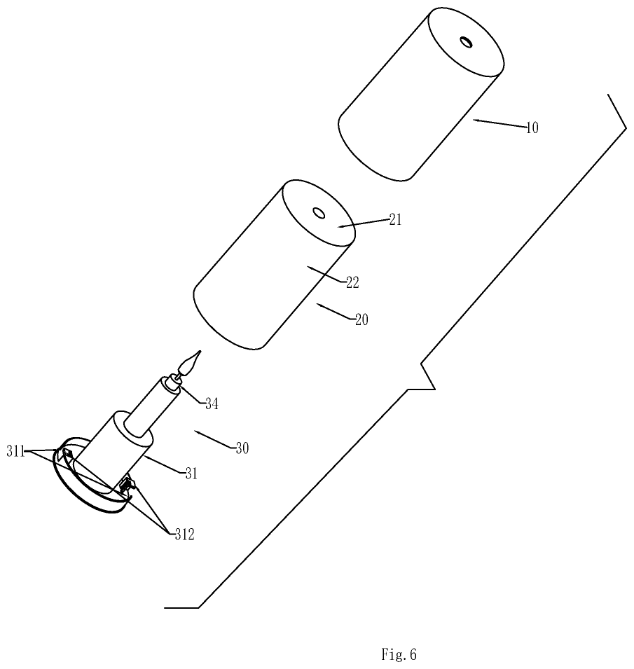

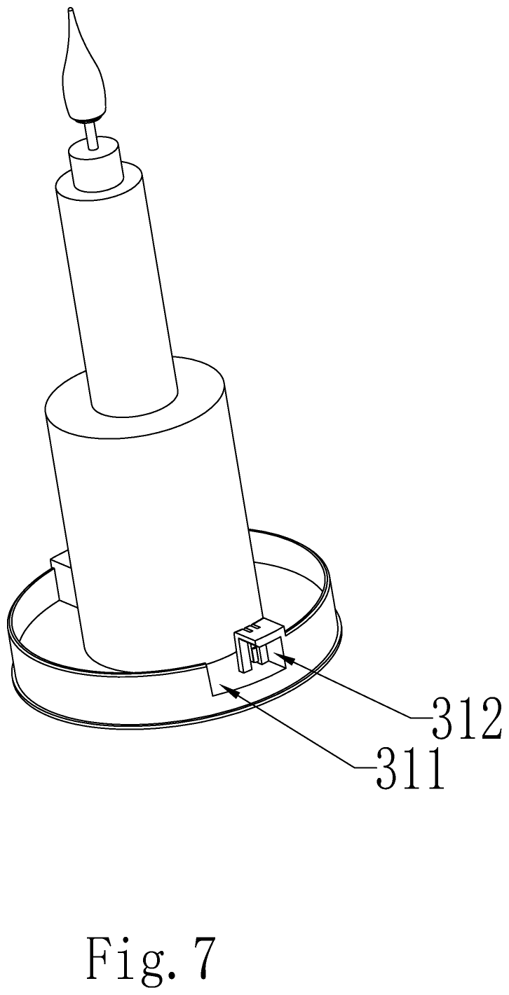

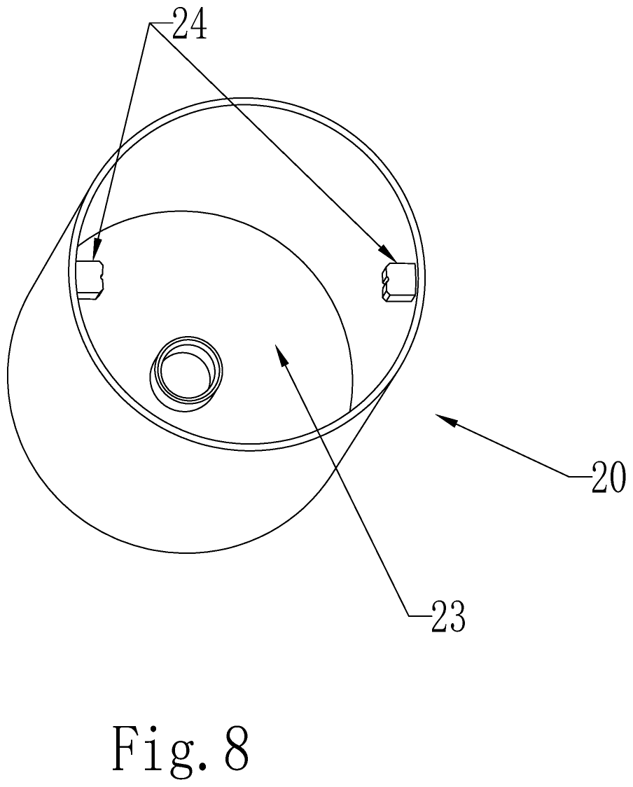

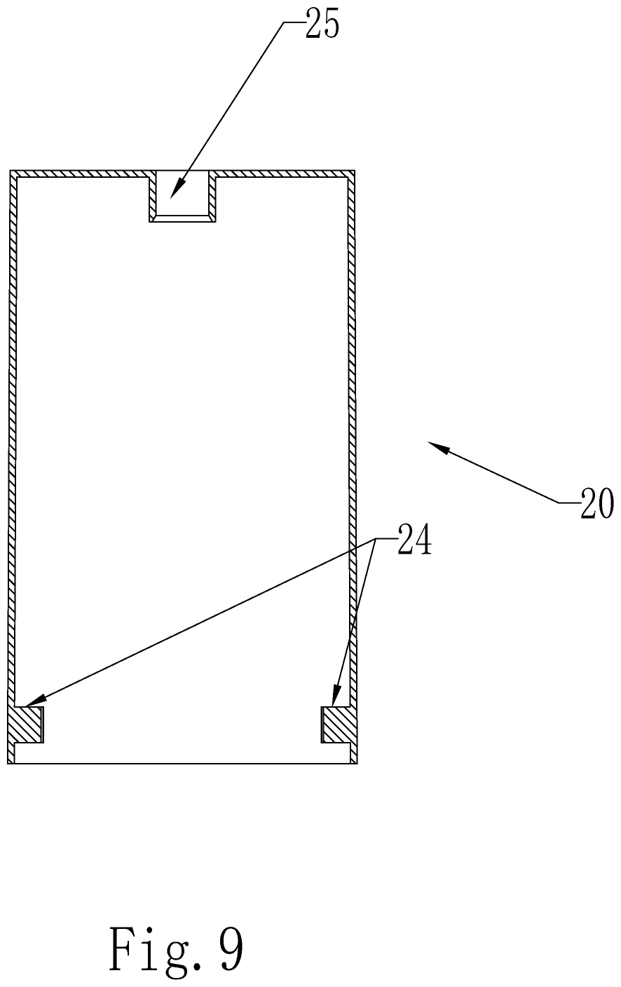

As shown in FIGS. 5 to 9, an electronic candle comprises a wax shell 10, a lining 20 and a core system 30. The lining 20 comprises an upper wall 21 and a side wall 22, and an inner space 23 enclosed by the upper wall and the side wall. The core system body 31 of the core system 30 is fixed to the inner space 23. In this embodiment, the lining 20 is made of semitransparent plastic material PP with an average wall thickness of 1.5 mm. The wax shell 10 is evenly wrapped on the outer surface of the lining 20, and the average wall thickness of the wax shell 10 is 0.6-3 mm, in this embodiment, the wall thickness is 1.5 mm. The lining 20 includes a fastening buckle 24. The core system 30 comprises a light source 32, a flame head 33 and a core system main body 31. The core system main body 31 comprises a clearance position 311, a fixing position 312, a light source control circuit, a battery (power supply) and a switch. The latter three are arranged in a conventional manner and are not shown in the figure. When the core system 30 is assembled to the lining 20, the fixing buckle 24 on the lining 20 is first placed in the clearance position 311, and then the lining 20 and the core system 30 are relatively rotated so that the fixing buckle 24 on the lining 20 is rotated to the fixing position 312 to be fixed. In this embodiment, the lining 20 further comprises a top fixing through hole 25, and the core system 30 further comprises a top central fixing cylinder 34 which is in contact with the top fixing through hole 25. The wax shell 10 is formed by directly cooling and solidifying melted wax on the outer surface of the lining 20, the outer surface of the wax shell is formed by the inner surface of a female mold, and the core system main body of the core system is fixed in the inner space of the lining.

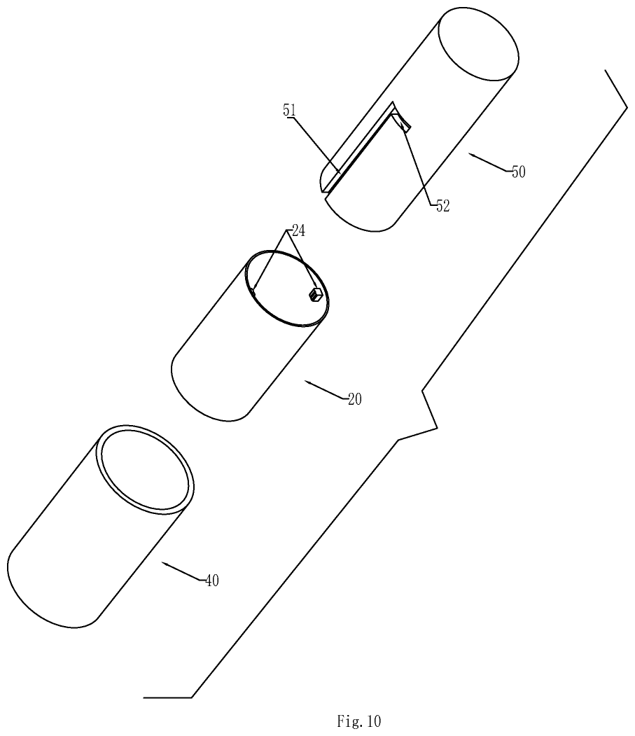

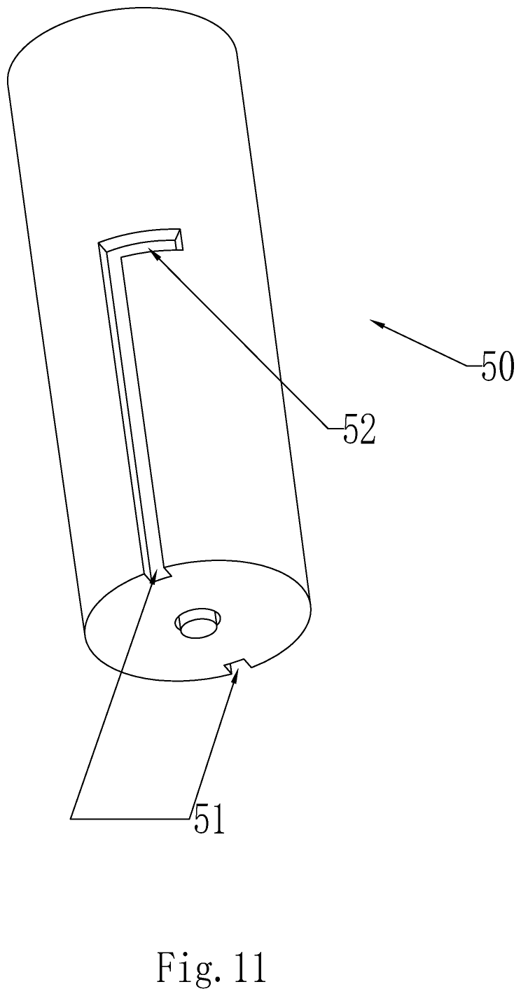

FIGS. 10-16 show a production method of an electronic candle. The production method comprises the use of at least two production molds: A female mold 40 and a male mold 50. The female mold 40 is used for forming the outer surface of the wax shell 10. In this embodiment, the male mold 50 is provided with a clearance groove 51 and a fixing groove 52, and the lining 20 is fixed on the male mold 50 by the following method: Align the fixing buckle 24 on the lining 20 with the clearance groove 51 on the male mold, move the lining 20 from bottom to top until the fixing buckle 24 is flush with the fixing groove 52, and rotate the lining 20 to the position where the fixing buckle 24 is clamped in the fixing groove 52. The demountable fixing mode of the lining and the male mold can also be achieved via screw or any other demountable fixing mode.

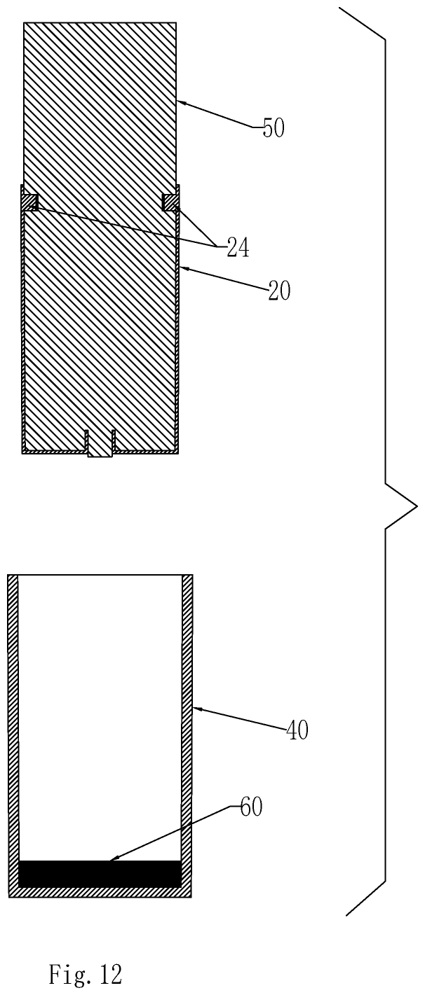

In this embodiment, the female mold 40 is made of a metal with good heat conductivity such as aluminum. Preferably, the cooling and solidifying duration of the melted wax can be reduced, and the production efficiency can be improved. FIG. 12 shows that mold-unlocking state before molding. The lining 20 is fixed on the male mold 50 above the female mold 40, and a certain amount of melted wax 60 is poured into the female mold 40. In this embodiment, the temperature of the melted wax 60 before being poured into the female mold 40 is about 110 degrees Celsius. In this embodiment, the formula of melted wax is 94% of fully refined paraffin wax model #58+6% of AC6 (hardened wax).

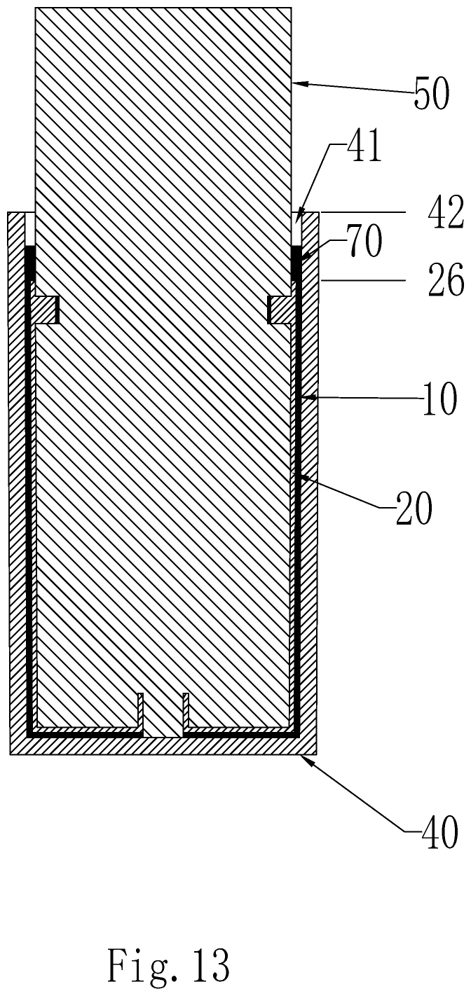

FIG. 13 shows a mold-locking state during molding. In this embodiment, the female mold 40 is held stationary, and the male mold 50 vertically descends to the mold-locking state. In other embodiments, the male mold may be kept stationary, and the female mold may vertically move upward to the mold-locking state, or both may simultaneously face each other in the vertical direction to the mold-locking state. In this embodiment, the melted wax 60 is squeezed to flow during descending of the male mold 50 to the mold-locking state and finally flows to form the shape of the wax shell during the mold-locking state. The distance from the lining bottom surface 26 to the mold top surface 42 is the height of the waste groove 41, which needs to be set to 5 mm or more. In this embodiment, this height is 20 mm. The waste groove 41 is in an open state, and air can enter the waste groove 41 from the outside of the female mold 40 and the male mold 50. Since the wax shell will shrink downwards in the cooling forming process, a rugged shape is usually formed at the bottom surface of the lining. The design of the waste groove can solve this problem. When the wax shell is formed each time, the melted wax is poured into the female mold in an appropriate amount so that the melted wax can rise above the bottom surface of the lining and flow into the waste groove to form excess waste wax in a mold-locking state. Further, the top of the waste groove cannot be closed by the male mold 50 to form a closed space, thereby isolating external air from entering the waste groove, which will affect the uniform shrinkage of liquid wax in the cooling process and cause the surface quality of the wax shell to decrease.

In this embodiment, the time for cooling and solidifying the melted wax until the mold can be disassembled is about 10 minutes. Compared with the cooling and solidifying duration of 0.5-3 hours in the existing production mode, the molding efficiency is improved many times.

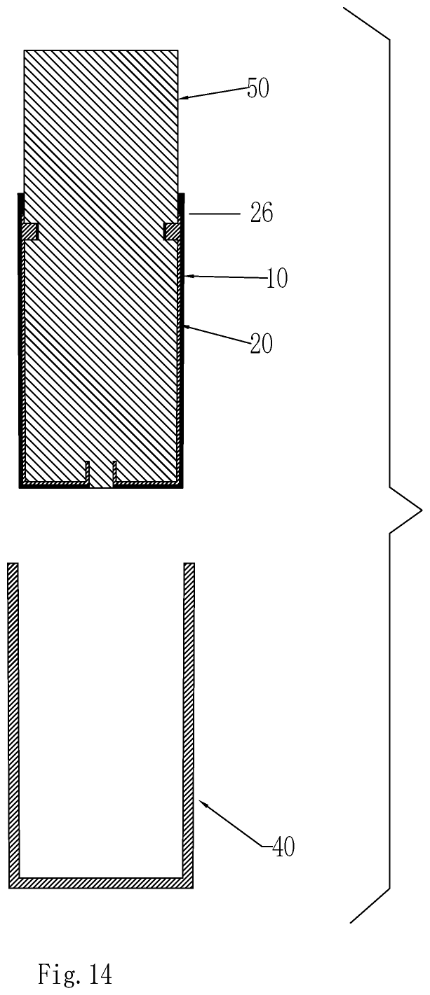

FIG. 14 shows the mold-unlocking state after molding. In this embodiment, the female mold 40 is held stationary, and the male mold 50 is vertically moved upward to the mold-unlocking state. The wax shell 10, together with the lining 20, is carried away from the female mold 40 by the male mold 50.

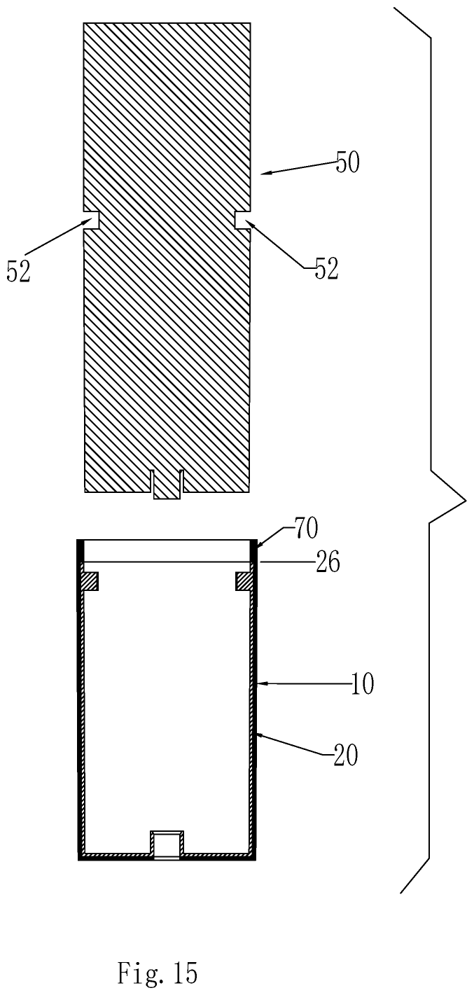

FIG. 15 shows a state in which the wax shell 10 and the lining 20 are removed from the male mold 50. In this embodiment, the wax shell 10 and the lining are rotated so that the fixing buckle 24 on the lining 20 is rotated from the position of the fixing groove 52 on the male mold 50 to the position of the clearance groove 51, and then the wax shell 10 and the lining 20 are pulled down out of the male mold 50.

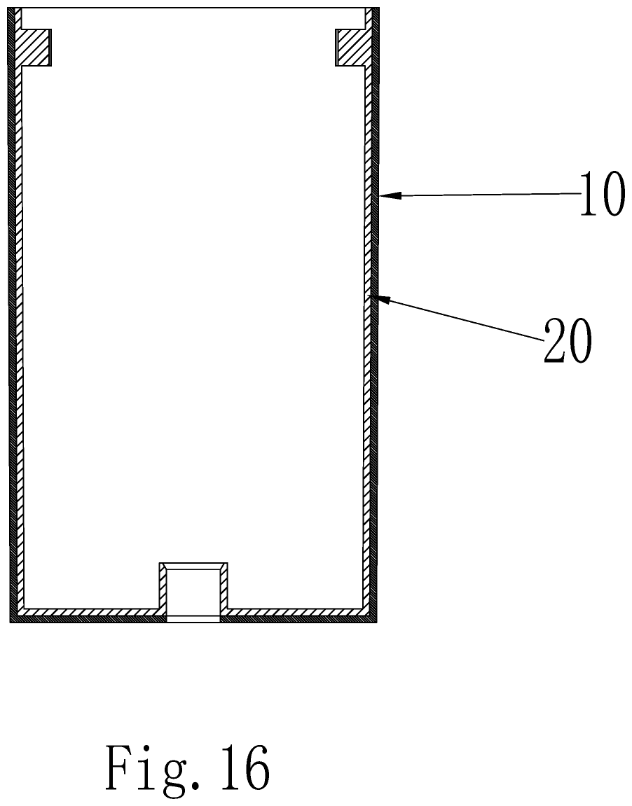

FIG. 16 shows the final required wax shell and lining component obtained from the lining bottom surface by removing excess waste wax 70 from the wax shell 10.

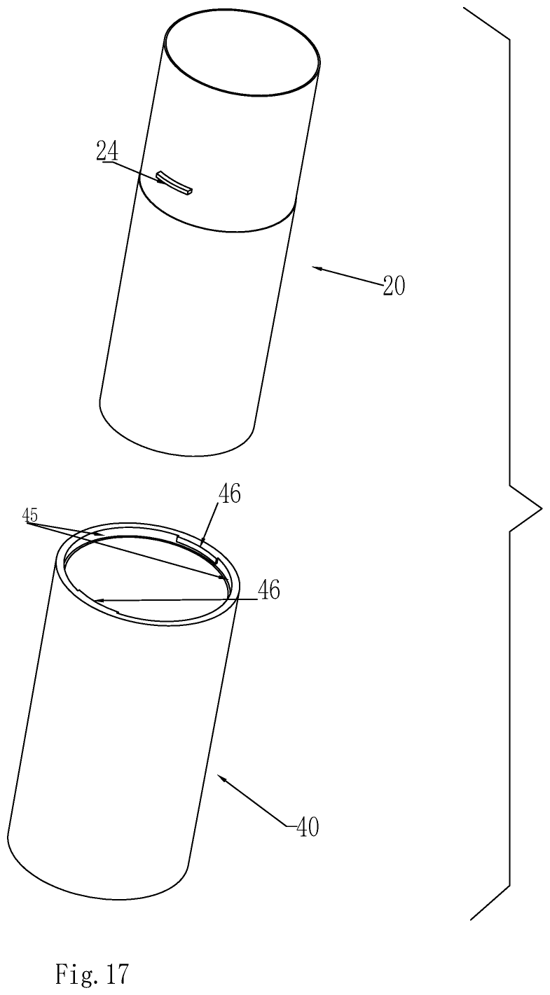

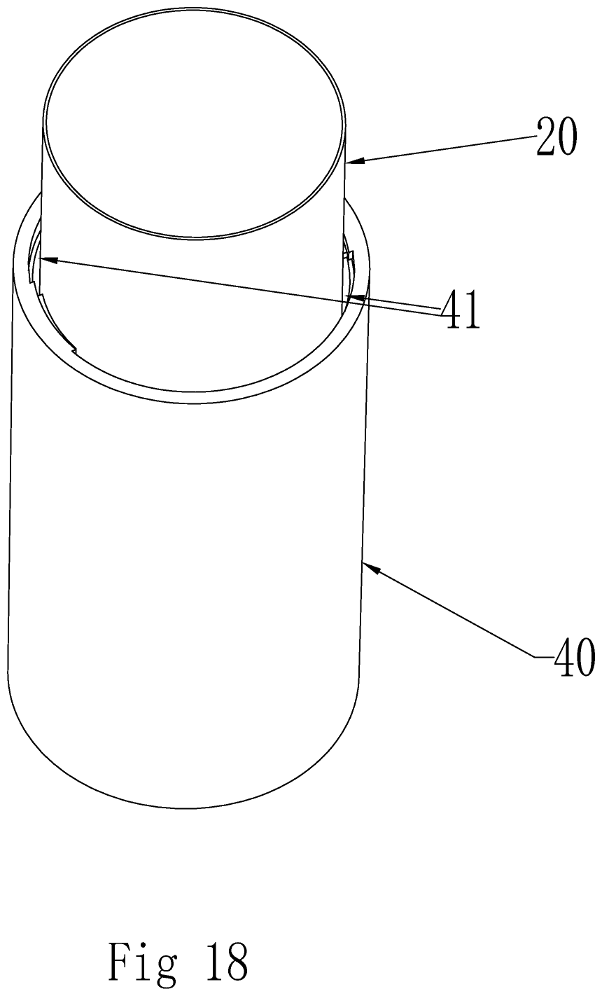

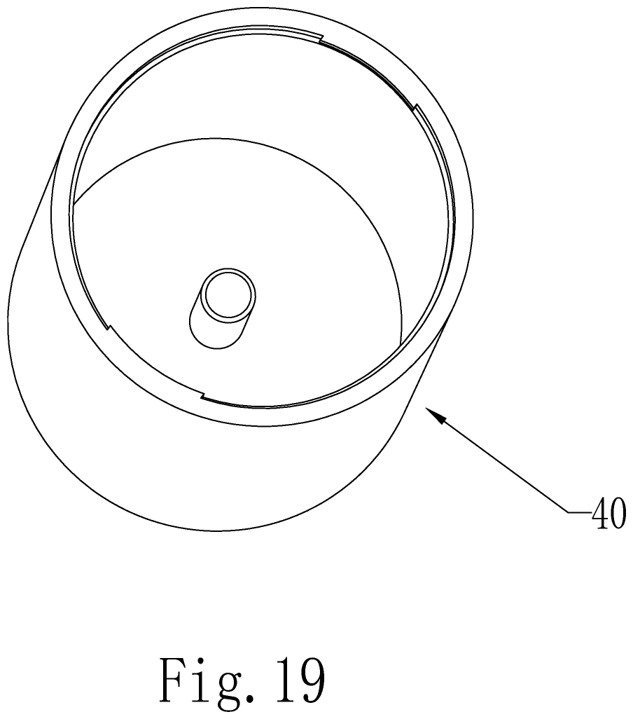

FIGS. 17-22 show another production method of the electronic candle. The production method includes the use of a female mold 40 and an uncut lining 20. The female mold 40 is used for forming the outer surface of the wax shell 10. In this embodiment, the female mold 40 is provided with a clearance position 45 and a fixing position 46. The uncut lining 20 is fixed on the female mold 40 by the following method: Align the fixing buckle 24 on the outer surface of the uncut lining with the clearance position 45 on the female mold 40 to assemble the uncut lining 20 into the female mold 40 from top to bottom, and then rotate the uncut lining to a position where the fixing buckle 24 is clamped in the fixing position 46. By reverse operation, it is available to remove the uncut lining 20 from the female mold 40.

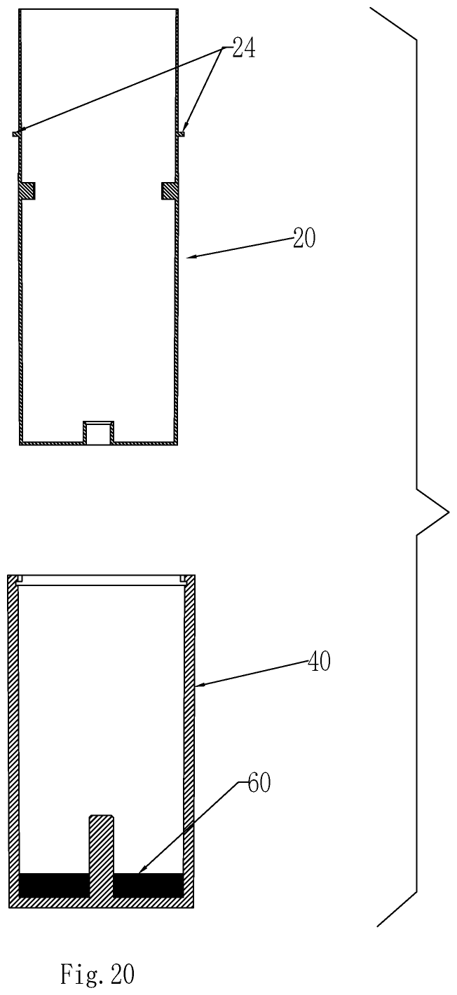

FIG. 20 shows a mold-unlocking state before molding. A certain amount of melted wax 60 is poured into the female mold 40. In this embodiment, the temperature of the melted wax before pouring into the female mold 40 is about 110 degrees Celsius, and the formula of the liquid wax is as follows: 94% of fully refined paraffin wax model #58+6% of AC6 (hardened wax).

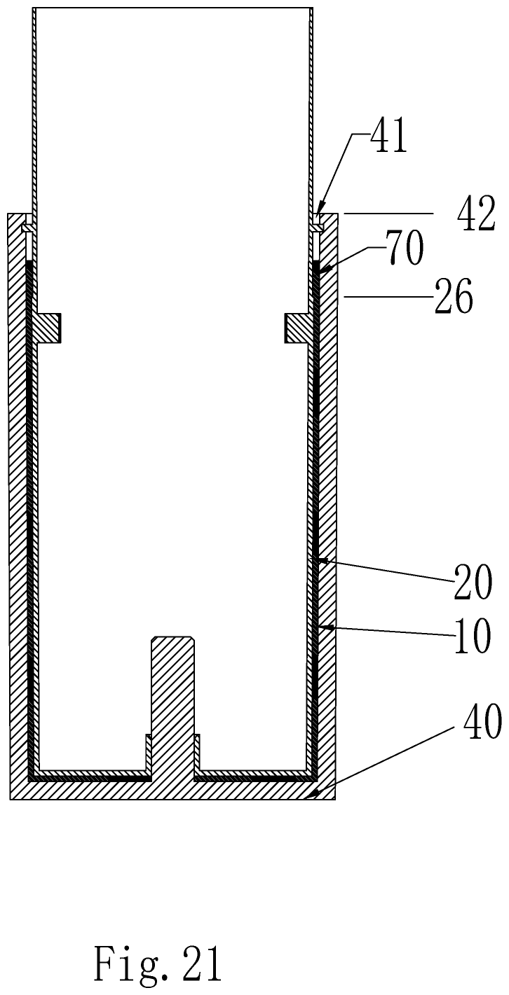

FIG. 21 shows a mold-locking state during molding. The uncut lining 20 is assembled to the female mold 40 while the uncut lining extrudes liquid wax to flow, thereby forming the shape of a wax shell. The other is the same as Embodiment 1.

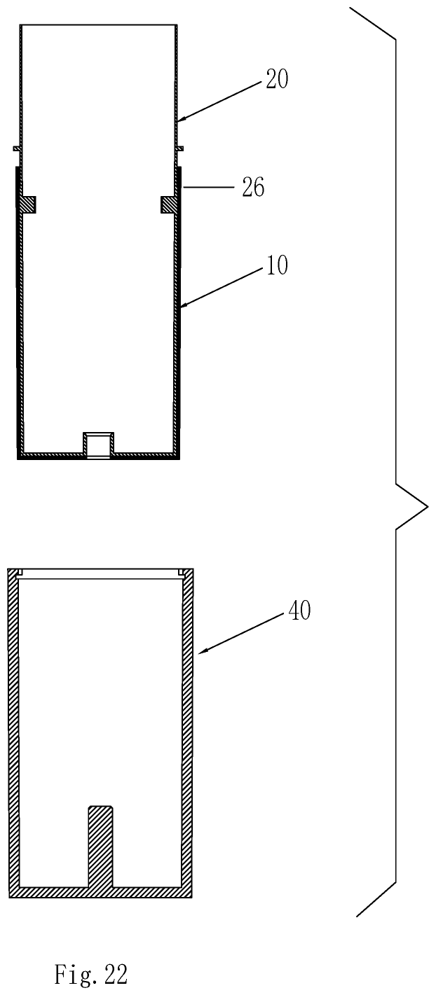

FIG. 22 shows a state in which the uncut lining 20 is removed from the female mold 40. After removal, the portion above the lining bottom surface 26 was cut to obtain a wax shell as shown in FIG. 16 in Embodiment 1.

The wax shell of the electronic candle is formed by directly cooling and solidifying melted melted wax on the outer surface of a lining, and the outer surface of the wax shell is formed by the inner surface of a female mold. Preferably, the average thickness of the wax shell is 0.6-3 mm. For the wax shell with an average thickness of less than 3 mm, due to its relatively small wall thickness, a small amount of wax used, and short molding cycle, it is advantageous to improve production efficiency; however, if the average thickness is less than 0.6 mm, it is not easy to obtain uniform and neat surface effect.

Preferably, the lining is made of a semitransparent or transparent material. Since the combination of the wax shell and the outer surface of the lining may not be completely compact in the process of forming the wax shell, especially in the case that the wall of the wax shell is very thin, when the outer surface of the wax shell is observed, the area of the combination that is not compact will easily show a different color from the area of the combination that is compact, and when the lining is made of semitransparent or transparent colorless or light-colored material, the inconsistent color of the outer surface of the wax shell will be greatly reduced, thereby improving the appearance quality of the product.

Preferably, the outer surface of the lining is rough rather than smooth, and the rough outer surface can make the outer surface of the lining better bond with the wax shell.

It should be understood that the above embodiments are only used to illustrate the technical solutions of the invention, rather than to restrict them. For those technicians in the art, the technical solutions recorded in the above embodiments can be modified, or some technical features therein can be equivalently replaced; and these modifications and substitutions shall belong to the protection scope of the claims attached to the invention.

1. An electronic candle, comprising
a wax shell, a core system and a lining;
the wax shell is formed by directly cooling and solidifying melted wax on the outer surface of the lining, the outer surface of the wax shell is formed by the inner surface of a female mold, and the main body of the core system is fixed in the inner space of the lining.

2. The electronic candle of claim 1, wherein the lining comprises an upper wall and a side wall, and an inner space enclosed by the upper wall and the side wall.

3. The electronic candle of claim 2, wherein the average wall thickness of the wax shell is 0.6 to 3 mm.

4. The electronic candle of claim 2, wherein the center of the lining upper wall is provided with a top fixing through hole, a top central fixing cylindrical surface is arranged below the flame head of the core system, and the top central fixing cylindrical surface is in contact with the top fixing through hole.

5. The electronic candle of any one of claims 2, 3 and 4, wherein the inner surface of the side wall of the lining is provided with at least two fixing buckles for fixing the core system on the lining.

6. The electronic candle of claim 5, wherein the core system is provided with a clearance position and a fixing position, when the core system is assembled on the lining, the fixing buckles on the lining are firstly placed on the clearance position, and then the lining and the core system are relatively rotated so that the fixing buckle on the lining is rotated to the fixing position on the core system to be fixed.

7. The electronic candle of any one of claims 1, 2, 3 and 4, wherein the lining is made of semitransparent or transparent material.

8. An electronic candle, comprising
a wax shell, a core system and a lining;
the lining comprises an upper wall and a side wall, and an inner space enclosed by the upper wall and the side wall; the main body of the core system is fixed in the inner space of the lining;
the wax shell is wrapped on the outer surface of the lining with a uniform wall thickness, and the average wall thickness of the wax shell is 0.6-3 millimeters.

9. The electronic candle of claim 8, wherein the lining is made of semitransparent or transparent material.

10. The electronic candle of claim 8 or 9, wherein the inner surface of the side wall of the lining is provided with at least two fixing buckles, and the fixing buckles are used for fixing the core system on the lining.

11. The electronic candle of claim 10, wherein the core system is provided with a clearance position and a fixing position, when the core system is fixed on the lining, the fixing buckle on the lining is firstly placed on the clearance position, and then the lining and the core system are relatively rotated so that the fixing buckle on the lining is rotated to the fixing position on the core system to be fixed.

12. A production method of an electronic candle, comprising
step 1: fix a lining on the outer surface of a male mold, and pour a certain amount of melted wax into a female mold;
step 2: place the male mold fixed with a lining into the female mold, extrude melted wax in the female mold to flow to a gap between the side wall of the lining and the side wall of the female mold and a gap between the upper wall of the lining and the bottom surface of the female mold, and cool and solidify the melted wax to form a wax shell;
step 3: sequentially take down the female mold and the male mold to obtain a wax shell lining component that wraps the wax shell outside the lining;
step 4: assemble the core system main body into the cavity of the wax shell lining component to complete the manufacturing process.

13. The production method of an electronic candle of claim 12, wherein in step 2, the height of the lining is lower than the height of the female mold, and a gap between the side wall of the female mold and the side wall of the male mold forms a waste groove above the female mold to contain excess melted wax.

14. The production method of the electronic candle of claim 13, wherein the height of the waste groove is more than 5 mm.

15. The production method of the electronic candle of claim 14, wherein the upper part of the waste groove is open.

16. The production method of an electronic candle of any one of claims 12, 13, 14 and 15, wherein the lining is made of semitransparent or transparent material.

17. The production method of an electronic candle of any one of claims 12, 13, 14 and 15, wherein the average wall thickness of the wax shell is 0.6 to 3 millimeters.

18. The production method of an electronic candle of any one of claims 12, 13, 14 and 15, wherein the inner surface of the side wall of the lining is provided with at least two fixing buckles, and the outer surface of the male mold is provided with at least two clearance grooves and fixing grooves corresponding to the fixing buckles; in the wax shell forming process, the fixing buckle of the lining passes through the clearance groove on the male mold from bottom to top, and when the fixing buckle reaches the height of the fixing groove, the lining is rotated by a certain angle so that the fixing buckle is clamped in the fixing groove; when the lining needs to be detached from the male mold, the lining is rotated in the opposite direction so that the fixing buckle is rotated to the position of the clearance groove, and the fixing buckle moves from top to bottom through the clearance groove, so that the lining is detached from the male mold.

19. The production method of an electronic candle of claim 18, wherein the core system is provided with a clearance position and a fixing position, when the core system is fixed on the lining, the fixing buckle on the lining is firstly placed on the clearance position, and then the lining and the core system are relatively rotated so that the fixing buckle on the lining is rotated to the fixing position on the core system to be fixed.

20. A production method of an electronic candle, comprising
step 1: pour a certain amount of melted wax into a female mold;
step 2: insert and fix a lining with a height higher than that of the female mold in the female mold from top to bottom, extrude melted wax in the female mold to flow to a gap between the side wall of the lining and the side wall of the female mold and a gap between the upper wall of the lining and the bottom surface of the female mold, and cool and solidify the melted wax to form a wax shell;
step 3: take down the female mold, and cut off the excess portion of the lining to obtain a wax shell lining component that wraps the wax shell outside the lining;
step 4: assemble the core system main body of the electronic candle core system into the cavity of the wax shell lining component to complete the manufacturing process.

21. The production method of an electronic candle of claim 20, wherein the female mold is provided with a clearance position and a fixing position, and the outer surface of the lining is provided with a fixing buckle; when the lining is fixed with the female mold, the fixing buckle on the outer surface of the lining is aligned with the clearance position on the female mold from top to bottom to assemble the lining into the female mold, and then the lining and the female mold are relatively rotated to a position where the fixing buckle is clamped at the fixing position to be fixed; the lining and the female mold are oppositely rotated away from the fixing position to remove the female mold.

22. A wax shell of an electronic candle, wherein the wax cylinder is formed by directly cooling and solidifying melted wax on the outer surface of a lining, and the outer surface of the wax shell is formed by the inner surface of a female mold.

23. The wax shell of the electronic candle of claim 22, wherein the average wall thickness of the wax shell is 0.6 to 3 mm.

24. The wax shell of the electronic candle of claim 22 or 23, wherein the lining is made of semitransparent or transparent material.
